(19) United States
(12) Patent Application Publication
(10) Pub. No.: US 2014/0027136 A1
(43) Pub. Date: Jan. 30, 2014

(54) Weed remover

(71) Applicant: James T. Chow, Toronto (CA)

(72) Inventor: James T. Chow, Toronto (CA)

(21) Appl. No.: 13/815,365

(22) Filed: Feb. 26, 2013

(30) Foreign Application Priority Data
Feb. 27, 2012 (CA) 2,769,807

(51) Int. Cl. A01B 33/10; A01B 39/19

(52) U.S. Cl. CPC A01B 33/106; A01B 39/19
USPC 172/378

(57) ABSTRACT

The weed remover has an elongated shaft provided with three or more prongs extending downwardly from its lower end. The prongs are arranged in a circle and are rotated by a handle at the top of the shaft. The prongs extend through openings in a plate which is slidable vertically between upper and lower positions. At the upper position, the prongs are exposed so that as they rotate, they function as an auger to make a circular groove in the ground surrounding a weed so that it can be pulled out. After the weed is removed, earth which adheres to the prongs as they rotate is removed by causing the plate to slide downward to the lower position. As the plate does so, it scrapes off earth which adheres to the prongs.

This Application claims priority pursuant to 35 USC 119 of Canadian application no. 2,769,807 filed on Feb. 27, 2012 the entire contents of which are hereby incorporated into the following application by reference.

### FIELD OF THE INVENTION

This invention relates generally to gardening implements and more particularly to a hand-held tool for removing weeds from a lawn or garden.

### BACKGROUND OF THE INVENTION

Tools for removing weeds and hand-operated by a gardener while he standing are widely available. Typical of such tools are those which are held vertically and have handles at their upper ends for activating claws or pincers at their lower ends. The claws or pincers of some such tools consist of a number of thin pointed rods which alternately come together or separate from one another by means of a push button at the upper end of the tool. When the rods are separated they can be placed around a weed and driven into the ground. The rods can the be closed around the weed so that it can be pulled from the ground. The claws or pincers of other such tools take the form of spikes which operate in the same way as the rods but have fewer than rods and for that reason are said to penetrate the earth more readily and for that reason can be driven into the ground with less effort.

Foot plates are provided at the lower ends of the tools so that the operator can drive the rods or spikes into the ground by applying downward pressure on them with his foot. There are a number of problems that result from the use of foot plates in this manner. One such problem is that the operator may lose his balance when he stands on the plate because only one of his feet is solidly on the ground. Being off balance, he may not operate the tool effectively or he may fall.

Another problem from driving the rods or spikes by foot is that when the tool must be tilted from the vertical to reach a weed, such as one adjacent to a wall or tree, the operator will not be able to put his full weight on the foot plate. What weight he can put on the foot plate may not be sufficient to drive the rods or spikes fully into the ground. Moreover, the rods or spikes, being inclined from the vertical may sever the root of the weed leaving its lower end in the ground where it can produce new growth to replace the growth that was removed.

I have invented a weed remover which in use avoids the problems mentioned above. Specifically, the operator of the tool can stand with both his feet solidly on the ground while he is driving the lower end into the ground. He drives the tool down by turning a handle while he presses down on it. He tilts the tool to the best angle to reach a weed without affecting the driving force which he can apply to the tool. Weeds close to trees or fences can as a result be easily removed while the operator is standing upright with both feet solidly on the ground.

### SUMMARY OF THE INVENTION

Briefly, the tool of my invention includes: a shaft disposed generally vertically in use; a rotatable handle for causing the shaft to rotate about a first axis and a grip for steadying the shaft while remaining stationary as the shaft rotates. A number of prongs extend downwardly from the shaft and rotate about the first axis as the shaft rotates. Each prong has a sharp lower end and sharp side edges. A lower plate has a handle for selectively causing the plate to slide vertically. The plate has edges which contact the prongs as the plate slides vertically downward for removing any earth adhering to the prongs.

### DESCRIPTION OF THE DRAWINGS

The weed remover of the invention is described with reference to the accompanying drawings in which:

FIG. 1 is an elevation of the weed remover;

FIG. 2 is a perspective view of the upper portion of the device;

FIG. 3 is a perspective view of device from the side of the device;

FIG. 4 is an elevation, in larger scale, of the interior of the lower portion of the device;

FIG. 5 is an exploded perspective view of the components of the lower portion of the device;

FIG. 6 is a perspective view of the lower portion and the interior of the device above the lower portion;

FIG. 7 is an exploded perspective view of the components of the device;

FIG. 8 is a perspective view of the interior of the lower portion of the device;

FIG. 9 is a perspective view of the interior of the device in which a plate for removing earth from the prongs is in an upper position;

FIG. 10 is another perspective view of the interior of the device in which the plate is in a a lower position.

Like reference characters refer to like parts throughout the description of the drawings.

### DESCRIPTION OF PREFERRED EMBODIMENT

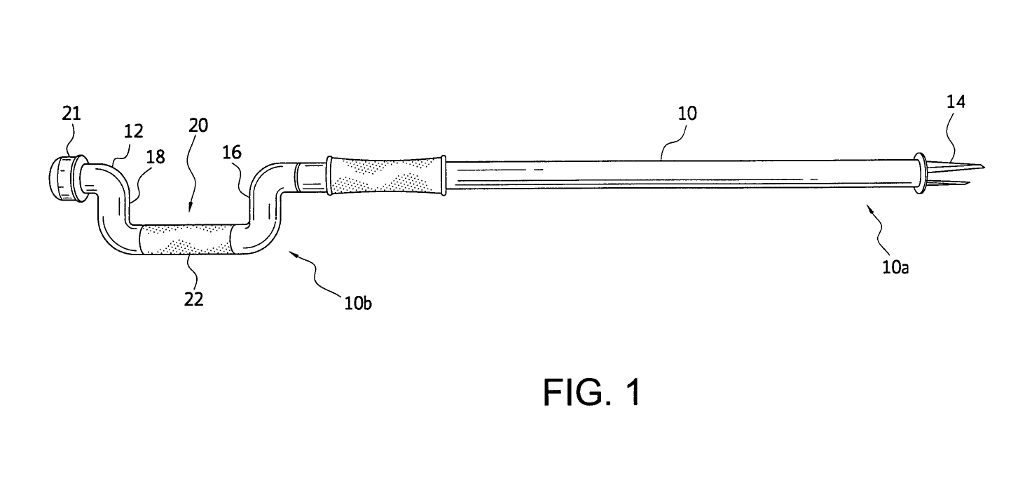

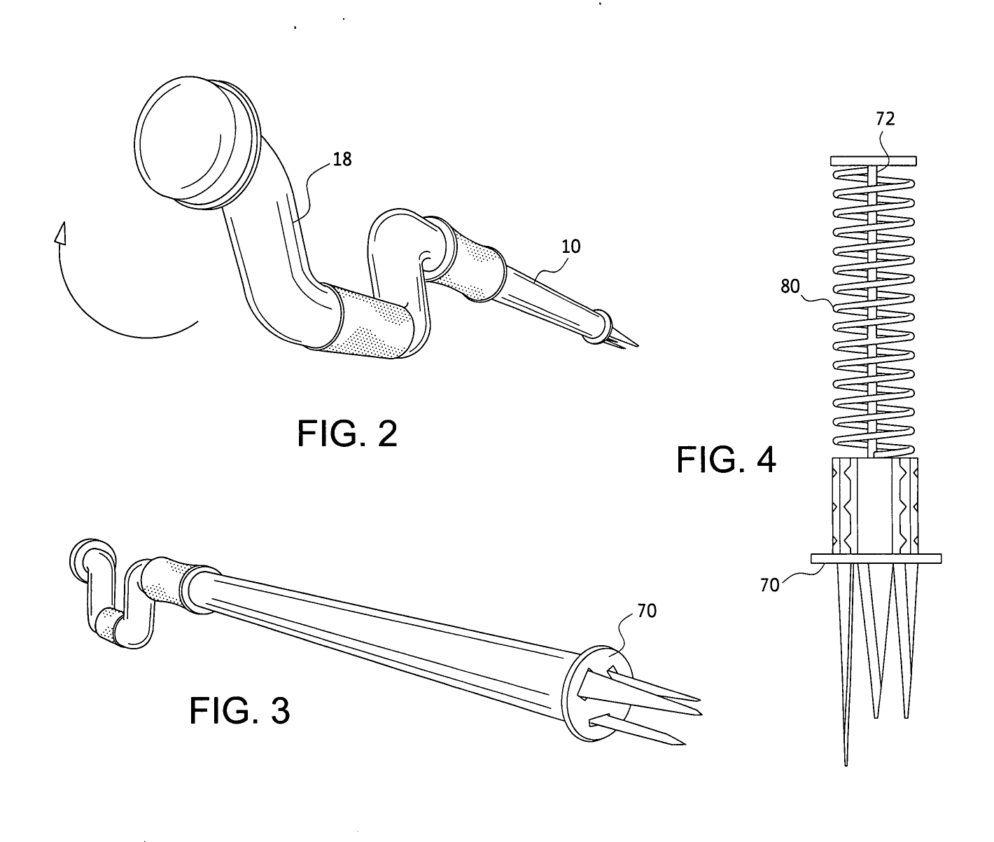

With reference to FIGS. 1 and 2, the weed remover comprises a shaft 10, a handle 12 at one end and a number of prongs 14 at the opposite end. The shaft has a longitudinal axis 10a-10a aout which it rotates. Henceforth the axis will be referred to as a “first axis”.

In use, the shaft is held generally vertically while the handle is above it and the prongs protrude from beneath it. In the following description, the shaft is assumed to be oriented in this way although in practice, it is not invariably so. When, for example, access to a weed is restricted by a tree or fence, the shaft may have to be tilted from the vertical to reach the weed.

The shaft is in the form of a tube having a lower portion, generally 10a, which is straight and an upper portion, generally 10b, which has a pair of lower and upper elbows 16, 18, respectively, between which a straight section, generally 20 extends. The handle includes a knob 21 which is mounted for rotation to the upper end of elbow 18.

A grip 22 is mounted concentrically about straight section 20. The grip is in the form of a sleeve or hollow cylinder of larger inner diameter than the outer diameter of the straight section. The grip has a longitudinal axis 22a-22a referred to below as a “second axis”.

The grip is free to rotate about the straight section and functions to steady the weed remover while it is being rotated. In this regard, the weed remover is rotated by holding the knob in one hand and holding the grip in the other. The knob is then rotated about the grip in the direction of the arrow in FIG. 2. As the knob rotates it will remain stationary relative to the hand in which it is held as will the grip in the other hand but the upper elbow 18 of the tool the remainder of shaft 10 will rotate relative to the knob. Thus, by means of the grip, the weed remover can be held steady in one hand while the other hand causes the device to rotate.

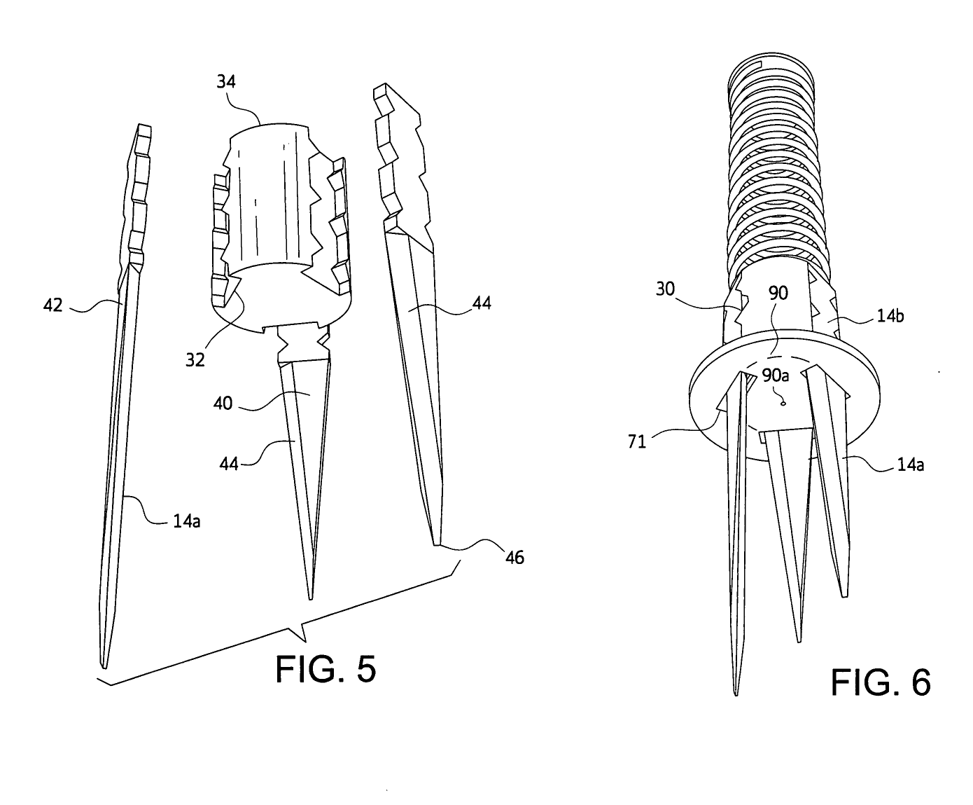

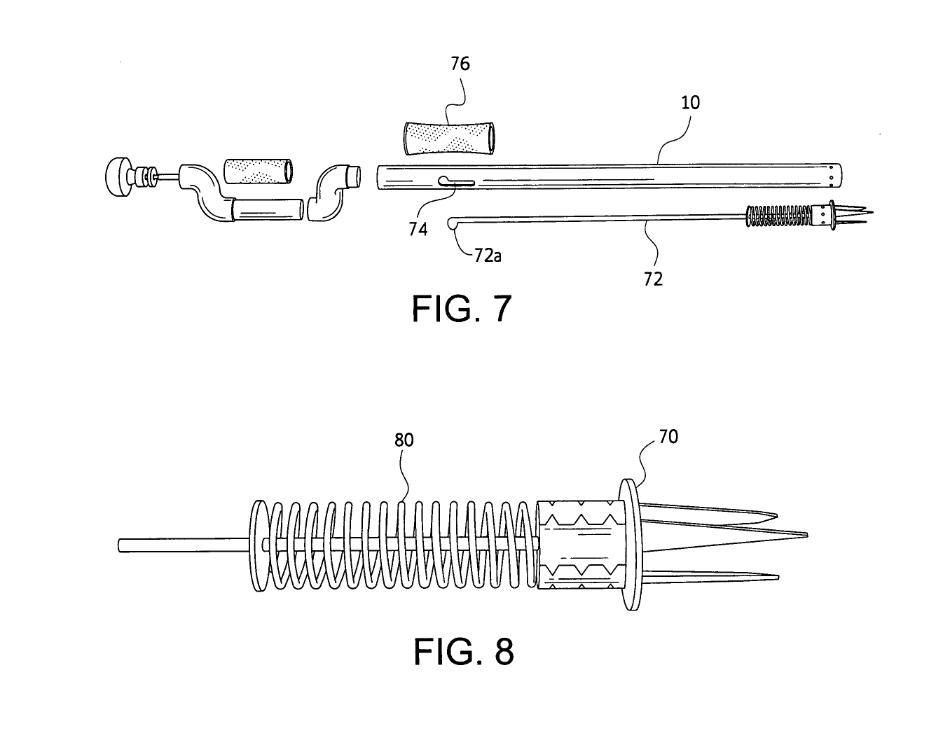

With reference to FIGS. 4-6, prongs 14 have protruding and non-protruding portions, 14a, 14b, respectively. The protruding portions 14a extend downwardly from the bottom of shaft 10. The non-protruding portions 14b have irregularly shaped side edges 30 and are received in conforming recesses 32 in a solid cylindrical shaped plug 34. The plug is friction-fit to the side walls of the tubular shaft so that as the shaft rotates so too does the plug and the prongs. As illustrated in FIG. 4, the protruding portions of the prongs are arrange along a circumference of an imaginary cylinder 35 and rotate about an axis 35a-35a referred to a s a “third axis”. The imaginary cylinder is a downward extension of the cylindrical shaft 10 and its third axis is an extension of the first axis 10a-10a.

The protruding portions of the prongs have oppositely facing inner and outer walls 40, 42 which narrow to an edge, preferably sharp, at their sides 43 and which converge downward to a point at 46.

One prong 14a is longer the other prongs and acts as a leader for the remaining prongs as the prongs form a cylindrical hole around a weed as they rotate.

With reference to FIGS. 8-10, a plate 70 is located beneath shaft 10. Openings 71 are formed in the plate through which the prongs extend. The plate is not attached to the prongs nor is it attached to the shaft. Rather the plate is attached to a rod 72 which extends upwardly through an opening in plug 34 and terminates at an L-shaped bend 72a. The bent portion of the rod extends through a vertical slot 74 in tubular shaft 10 and is attached to a slidable extractor 76. The plate is shown as circular in the drawings but may be of any shape as long as it functions to remove earth that adheres to the prongs.

Extractor 76 like grip 22 is in the form of a sleeve of larger inner diameter than the outer diameter of the tube so that the extractor is vertically slidable on the tube. Resilient means in the form of a coil spring 80 surrounds rod 72 within the tube and biases plate 70 upwardly against the lower edge of the shaft unless a downward force opposed to the bias of the spring is applied to the extractor.

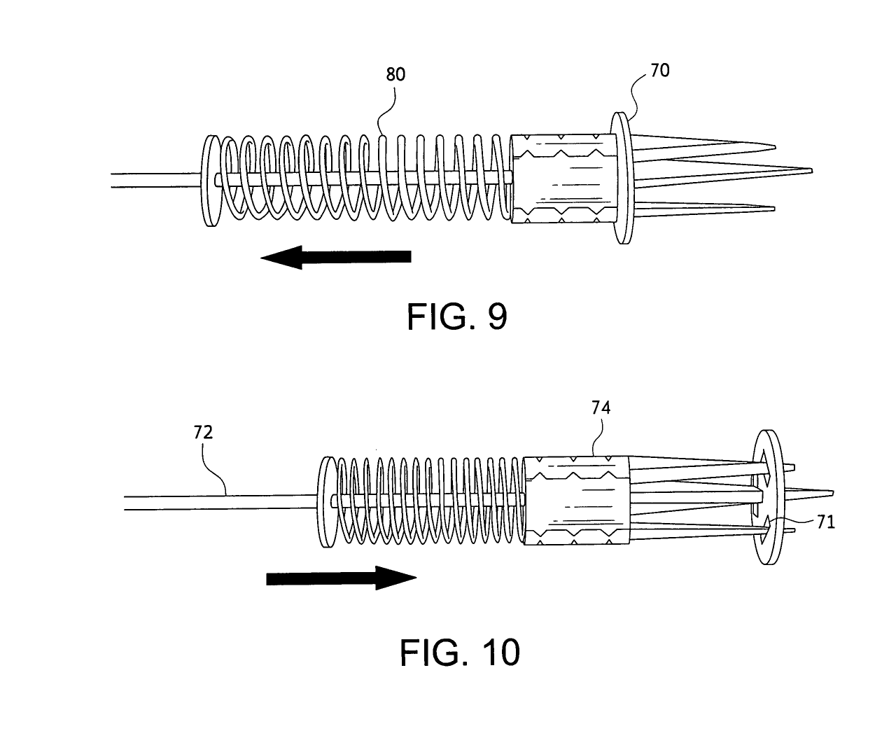

In operation, and with reference first to FIG. 9 the weed remover is placed adjacent to a weed to be removed so that the weed is encircled by the prongs. The handle is then rotated while a downward force is applied on the tool to cause the prongs to act as an auger for cutting a cylindrical shaped hole in the earth surrounding the weed. The device is then lifted in order to raise the clod of earth within the prongs together with the weed. With reference to FIG. 10, the extractor 76 is then slid downward and it does so, the edges of the openings 71 in the plate are close enough to the prongs that they function to scrape off the earth which adheres to the prongs. The edges do not however make contact with the prongs and interfere with the downward and upward movement of the plate.

It will be understood, of course, that modifications can be made in the structure of the device without departing from the scope and purview of the invention as defined in the appended claims.

I claim:

1. A weed remover including: a shaft disposed generally vertically in use; a rotatable handle for causing said shaft to rotate about a first axis; a grip for steadying said shaft while remaining stationary as said shaft rotates; a plurality of prongs extending downwardly from said shaft and rotating about said first axis as said shaft rotates, each said prong having a sharp lower end and sharp side edges; a lower plate having a handle for selectively causing said plate to slide vertically, said plate having edges which contact said prongs as said plate slides vertically downward for removing any earth adhering to said prongs.

2. The weed remover of claim 1 wherein said grip is a sleeve disposed concentrically about said shaft.

3. The weed remover of claim 2 wherein said sleeve has a longitudinal second axis, said axis being offset from said first axis.

4. The week remover of claim 1 wherein said prongs are arranged along a circumference of an imaginary cylinder having a longitudinal third axis which lies on said first axis.

5. The weed remover as claimed in claim 1 further including resilient means for biasing said plate upward.

6. The weed remover of claim 1 wherein said shaft is a tube having a hollow interior, said prongs being mounted to a plug which is fixed to said hollow interior, said plate being slidable relative to said prongs and having openings defined by said edges through which said prongs extend.

7. A weed remover including: a shaft disposed generally vertically in use; a rotatable handle for causing said shaft to rotate about a first axis; a grip for steadying said shaft while remaining stationary as said shaft rotates; said grip being in the form of a sleeve having a longitudinal second axis, said second axis being offset from said first axis; a plurality of prongs extending downwardly from said shaft and rotating about said first axis as said shaft rotates, each said prong having a pointed lower end and oppositely facing sharp side edges; a lower plate having a handle for selectively causing said plate to slide vertically, said plate having edges which contact said prongs as said plate slides vertically downward for removing any earth adhering to said prongs.

8. The week remover of claim 7 wherein said prongs are arranged along a circumference of an imaginary cylinder having a longitudinal third axis which lies on said first axis.

9. The weed remover as claimed in claim 7 further including resilient means for biasing said plate upward.
